(19) United States
(12) Patent Application Publication
(10) Pub. No.: US 2013/0169021 A1
(43) Pub. Date: Jul. 4, 2013

(54) LOCKING MEMBER OF VEHICLE SEAT DEVICE, VEHICLE SEAT DEVICE, AND SEAT PLACEMENT BODY

(71) Applicant: SHIROKI CORPORATION, KANAGAWA (JP)

(72) Inventors: Masafumi JINNO, Kanagawa (JP); Kazuyuki FUKUYAMA, Kanagawa (JP)

(73) Assignee: SHIROKI CORPORATION, KANAGAWA (JP)

(21) Appl. No.: 13/780,318

(22) Filed: Feb. 28, 2013

Related U.S. Application Data
(63) Continuation of application No. PCT/JP2011/064019, filed on Jun. 20, 2011.

(30) Foreign Application Priority Data
Sep. 14, 2010 (JP) 2010-206027

(51) Int. Cl. B60N 2/44

(52) U.S. Cl. CPC B60N 2/442
USPC 297/463.1

(57) ABSTRACT

The present invention achieves a locking member of a vehicle seat device, a vehicle seat device, and a seat placement body, in which the lateral movement amount of the seat when receiving lateral movement acceleration can be suppressed without reducing the length of the engaging portion of the striker.

The solution is a locking member provided with a striker, and a movement restriction member which is fixed to at least one side piece so that positions in the leftward/rightward direction of at least one part of the movement restriction member are the same as those of the left and right curved corner portions, wherein the movement restriction member includes a side spacer which forms a gap in the leftward/rightward direction between the engaging portion and the lock mechanism, to which the engaging portion is engaged.

### RELATED APPLICATION DATA

This is a continuation of International Application No. PCT/JP2011/064019, with an international filing date of Jun. 20, 2011, which is herein incorporated by reference in its entirety.

### TECHNICAL FIELD

The present invention relates to a locking member of a vehicle seat device, a vehicle seat device, and a seat placement body.

### BACKGROUND ART

A stowable seat device provided with a seat that is movable between a usage position, at which the seat is mounted on a seat placement surface formed on a vehicle floor, and a storage position, at which the seat is stored in a storage recess that is formed on the vehicle floor at position displaced in the forward/rearward direction (of the vehicle) from the seat placement surface, is known in the art (e.g., Patent Literature 1).

One of the underside of the seat and the seat placement surface is provided with a striker, made of metal, projecting therefrom (fixed thereto), and the other of the underside of the seat and the seat placement surface is provided with a lock mechanism (provided with a rotatable hook which is disengageably engageable with the striker and a pawl which can hold the hook at a locked position) which is disengageably engageable with the striker. Upon moving the seat that is positioned at the storage position to the usage position, the lock mechanism locks the striker, so that the seat is held at the usage position.

### CITATION LIST

### Patent Literature

PATENT LITERATURE 1: Japanese Unexamined Patent Publication No. 2008-260325.

PATENT LITERATURE 2: Japanese Unexamined Patent Publication No. 2009-166605.

### SUMMARY OF INVENTION

### Technical Problem

When driving around sharp corners, or when another vehicle collides with a side surface of the vehicle, etc., a lateral movement acceleration occurs in the vehicle. If the seat moves by a large amount in the lateral direction due to this movement acceleration, since it becomes difficult to ensure rigidity of the seat, it is desirable to suppress the lateral movement amount of the seat down to a predetermined amount or less in the event of movement acceleration occurring.

In order to reduce the lateral movement amount of the seat, the width of the striker in the leftward/rightward direction should be narrowed, and the clearance in the leftward/rightward direction between the inner surface of the striker and the lock mechanism (hook), when the striker is locked by the lock mechanism (hook), should be reduced. Accordingly, when the seat moves in a lateral direction due to lateral movement acceleration, since the inner surface of the striker impacts the lock mechanism (hook) at a timing in which the striker slightly moves laterally (at an instant at which the movement speed is slow), it is possible to suppress the lateral movement amount of the seat using the striker and lock mechanism (hook).

However, it is difficult to narrow the lateral width of the striker.

FIG. 8 is a front elevational view showing a striker having a common structure, and a lock mechanism (hook) which is engaged with the striker. The striker is integrally provided with a pair of left and right side pieces which are mutually parallel to each other and extend downward from the underside of the seat, and an engagement portion which extends in a straight line in the leftward/rightward direction and is disengageably engageable with the lock mechanism (hook). Since the striker is formed into the shape shown in the drawing by bending a metal rod, it is difficult to bend each connecting portion between the lower ends of the side pieces and the side ends of the engaging portion into a right-angle, so that a curved corner portion is inevitably formed at each connection portion, as shown in the drawing.

In a striker having such a shape, if the dimensions L1 in the leftward/rightward direction of the engaging portion is shorted, the width (distance between opposing surfaces) L2 in the leftward/rightward direction of the left and right side pieces can be shortened. However, in order to smoothly engage the striker with the lock mechanism (hook), it is necessary to design the length of the engaging portion to be longer than the thickness of the lock mechanism (hook), and furthermore, since it is necessary to increase the thickness of the hook by a certain amount in order to ensure a lock strength of the striker and the lock mechanism (hook), the dimensions L1 in the leftward/rightward direction cannot be drastically reduced.

Furthermore, since a pair of left and right curved corner portions are formed in the striker, as described above, the width L2 in the leftward/rightward direction is increased by the amounts of the left and right curved corner portions.

The present invention provides a locking member of a vehicle seat device, a vehicle seat device, and a seat placement body, in which the lateral movement amount of the seat when receiving lateral movement acceleration can be suppressed, without reducing the length of the engaging portion of the striker.

### Solution to Problem

A locking member of a vehicle seat device according to the present invention is characterized by including a vehicle seat device provided with a seat which is installable onto and removable from a seat placement portion formed on a seat placement body, and a lock mechanism provided on one of the seat placement portion and the seat, wherein the locking member is provided on the other of the seat placement portion and the seat and the locking member is locked by the lock mechanism when the seat is installed onto the seat placement portion. The locking member includes a striker provided with a pair of left and right side pieces which extend from the other of the seat placement portion and the seat; a pair of curved corner portions which curve in directions mutually toward each other from ends of the pair of side pieces; and an engaging portion, linearly extending in the leftward/rightward direction, which is connected to the pair of curved corner portions and is disengageably engaged with the lock mechanism; and a movement restriction member including at least one side spacer which forms a gap in the leftward/rightward direction between the engaging portion and the lock mechanism, to which the engaging portion is engaged, the side spacer being fixed to at least one side piece so that positions in the leftward/rightward direction of at least one part of the movement restriction member are the same as those of the left and right curved corner portions.

The side spacer can be a pair of left and right side spacers.

In this case, the movement restriction member is provided with an interconnecting portion which connects the ends of the other of the seat placement portion and the seat of the pair of side spacers, and is fixed to the pair of side spacers.

In either case of there being one or a pair of side spacers, the movement restriction member contacts the other of said seat placement portion and said seat.

Furthermore, the movement restriction member is provided with a contacting portion which extends forwardly or rearwardly from the striker, and which contacts the other of the seat placement portion and the seat.

In this case, it is desirable for the contacting portion is provided with a projection which fits in a hole or a recess that is formed in the other of the seat placement portion and the seat.

It is possible to apply the present invention as a vehicle seat device, wherein the locking member is mounted onto the seat which is installable onto and removable from the seat placement portion, which is provided with the lock mechanism.

Furthermore, it is also possible to apply the present invention as a seat placement body, including the locking member, and wherein the seat, which is provided with the lock mechanism, is installable and removable with respect to the seat placement body.

### ADVANTAGEOUS EFFECTS OF INVENTION

According to the present invention, the gaps in the leftward/rightward direction between the left and right side spacers and the lock mechanism, when the lock mechanism is engaged with the engaging portion of the striker, is shorter than the distance between the lock mechanism and the left and right side pieces. Therefore, even if the seat is moved in the lateral direction by a lateral acceleration, since the side spacer collides with the lock mechanism at a timing in which the striker slightly moves relative to the lock mechanism in the lateral direction (at an instant at which the movement speed is slow), the lateral movement amount of the seat can be reduced using the locking member (the striker and the movement restriction member) and the lock mechanism.

Moreover, since a reinforcement effect in which the rigidity of the striker (locking member) can be improved can be achieved by providing the side spacer, the risk of the striker (locking member) deforming due to the impact thereof with the lock mechanism can be decreased.

### BRIEF DESCRIPTION OF DRAWINGS

FIG. 1 is a side elevational view showing a sectional view of inside a vehicle in which a vehicle seat device according to an embodiment of the present invention is mounted;

FIG. 2 is a front perspective view of a bracket and a locking member, viewed obliquely from below;

FIG. 3 is a rear elevational view of the bracket and the locking member;

FIG. 4 is a side elevational view of the bracket and the locking member;

FIG. 5 is a rear perspective view of a modified embodiment of the bracket and the locking member, viewed obliquely from below;

FIG. 6 is a rear elevational view, similar to that of FIG. 3, of the modified embodiment;

FIG. 7 is a side elevational view, similar to that of FIG. 4, of the modified embodiment; and

FIG. 8 is a front elevational view showing a striker and a lock mechanism (hook) that is engaged with the striker according to the prior art.

### DESCRIPTION OF EMBODIMENTS

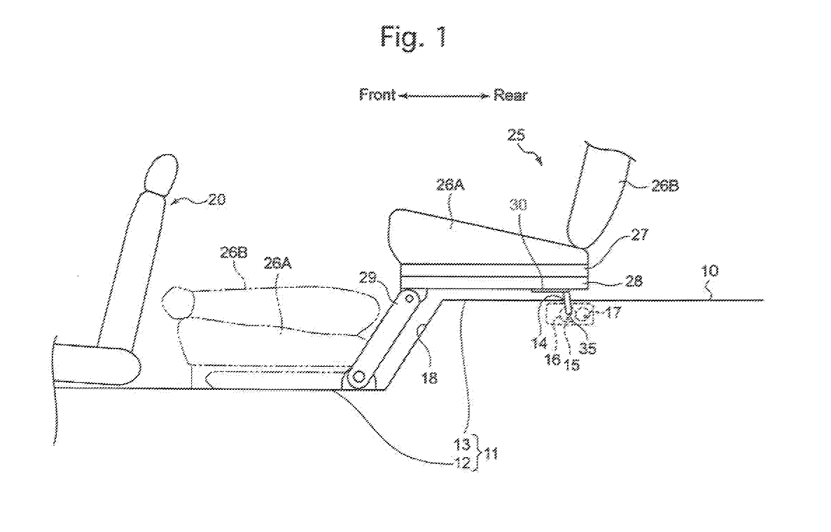

An embodiment of the present invention will be hereinafter discussed with reference to FIGS. 1 through 4. Note that directions described in the following description are defined based on the directions of arrows shown in the drawings.

FIG. 1 is a side elevational view showing a sectional view of inside an automobile (vehicle). As shown in FIG. 1, a vehicle floor 10 of the automobile is provided with a stepped floor 11 having a front low-level floor (storage recess) 12, and a high-level floor (seat placement portion) 13 positioned immediately behind the low-level floor 12.

As shown in FIG. 1, a pair of left and right though-holes 14 are formed through a floor board that constitutes the high-level floor 13, and a lock mechanism 15 is provided in the lower space positioned immediately below the left and right though-holes 14. The lock mechanism 15 is a known mechanism that is provided with a hook 16 and a pawl 17, both of which are rotatable about an axis extending in the left and right directions. The hook 16 is provided with an engaging groove which is disengageably engageable with a striker 36 (engaging portion 37), which will be discussed hereinafter. The hook 16 is rotatable between a locked position, and an unlocked position rotated by a predetermined angle in the anti-clockwise direction from the locked position shown in FIG. 1. The pawl 17 is rotatable between an engaged position, at which the pawl 17 engages with the hook 16 that is positioned at the locked position and holds the hook 16 at the locked position, and a disengaged position, at which the pawl 17 cannot be engaged with the hook 16 that has rotated by a predetermined angle in the anti-clockwise direction from the locked position shown in FIG. 1. Furthermore, since a tension spring (not shown) is attached between the hook 16 and the pawl 17, the hook 16 is rotatably biased toward the unlocked position by the biasing force of this tension spring, and the pawl 17 is rotatably biased toward the engaged position by the biasing force of this tension spring.

Furthermore, a lock-release device, not shown in the drawings, is provided on an inclined connecting surface 18 which connects the rear end of the low-level floor 12 with the front end of the high-level floor 13, and this lock-release device is interconnected with the pawl 17. When the lock-release device is not operated, the pawl 17 is positioned at the engaged position by the biasing force of the tension spring, however, when the lock-release device is operated, the pawl 17 moves to the disengaged position against the biasing force of the tension spring.

Two front and rear rows of seats 20 and 25 are provided on the vehicle floor 10, and the front row seat 20 is mounted on the low-level floor 12.

The rear row seat (seat) 25, which is a stowable seat, has the following-described structure that is rotatably movable between the low-level floor 12 and the high-level floor 13 in the forward/rearward direction (and the upward/downward direction).

A seat back 26B is connected to the rear end of a seat cushion 26A to be rotatable about a rotational axis extending in the leftward/rightward direction. A pair of left and right metal upper rails 27 extending in the forward/rearward direction are fixed to the underside of the seat cushion 26A, and a pair of left and right metal lower rails 28 are respectively engaged with the lower sides of the left and right upper rails 27 to be slidable therealong in the forward/rearward direction. A slidable lock-mechanism (not shown) is provided between the upper rails 27 and the lower rails 28 which can be operated by an operation handle, not shown in the drawings. When the operation handle is not operated, since the slidable lock-mechanism enters a locked state, the upper rails 27 and the lower rails 28 are prevented from relatively sliding, and when the operation handle is operated, since the slidable lock-mechanism enters an unlocked state, relative sliding between the upper rails 27 and the lower rails 28 becomes possible.

Upper ends of a pair of left and right links 29 are connected to brackets that extend downwardly from the front ends of the left and right lower rails 28, respectively, so that the left and right links 29 are rotatable about a rotational axis extending in the leftward/rightward direction. The lower end portions of the left and right links 29 are connected a pair of left and right brackets, respectively, that project from the low-level floor 12, so that the left and right links 29 are rotatable about a rotational axis extending in the leftward/rightward direction with respect to the brackets. Accordingly, the seat cushion 26A, the seat back 26B, the upper rails 27 and the lower rails 28 are rotatably moved in the forward/rearward direction (and the upward/downward direction) between the low-level floor 12 and the high-level floor 13 by rotating the left and right links 29 in the forward/rearward direction. If the left and right links 29 are rotated forwardly with the seat back 26B folded onto the seat cushion 26A, the seat cushion 26A, the seat back 26B, the upper rails 27 and the lower rails 28 move to a storage position at which they are placed on the low-level floor 12, as shown by the phantom lines in FIG. 1. Whereas, if the left and right links 29 are rotated rearwardly, the seat cushion 26A, the seat back 26B, the upper rails 27 and the lower rails 28 move to a usage position (the position shown by solid lines in FIG. 1) that is positioned immediately above the high-level floor 13.

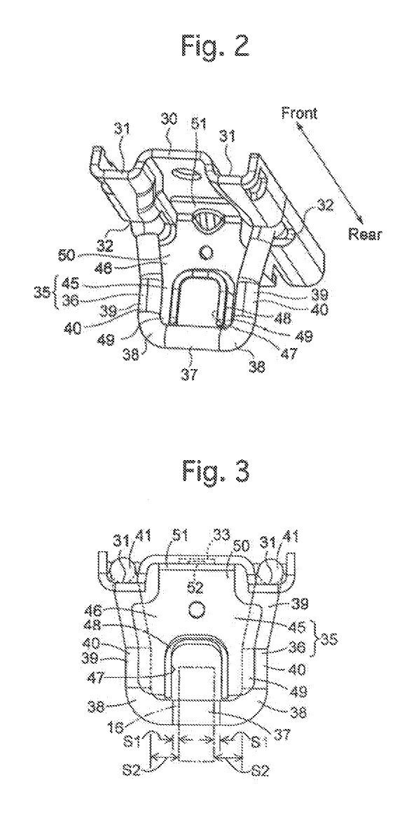

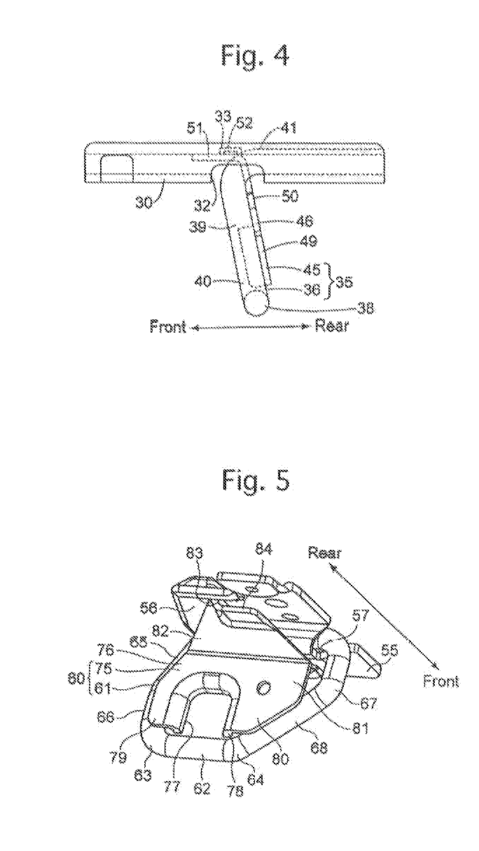

Metal brackets 30 are fixedly welded to the undersides of the left and right lower rails 28 near the rear ends thereof. As shown in FIGS. 2 and 3, each bracket 30 is a substantially a W-section member that extends in the forward/rearward direction and is provided with a pair of left and right striker mounting grooves 31 on the upper side thereof. Furthermore, the left and right sides of each bracket 30 are provided with insertion holes 32, respectively, which are communicably connected with the left and right striker mounting grooves 31 positioned immediately above thereof and the space therebelow. Furthermore, a recess 33 is formed in the underside of the bracket 30, at the central portion thereof with respect to the leftward/rightward direction (see FIGS. 3 and 4).

The bracket 30 is integrated with a locking member 35, which is provided with the striker 36 and a movement restriction member 45 that are both made from metal.

The striker 36 is a bilaterally symmetrical member that formed by bending a straight metal rod, which has a circular sectional shape. The striker 36 is provided with an engaging portion 37 which extends linearly in the leftward/rightward direction and constitutes a lower end of the striker 36, a pair of left and right curved corner portions 38 which curve in an arcuate shape upwards from the left and right ends of the engaging portion 37, respectively, a pair of left and right side pieces 39 which extend upwardly from the upper ends of the left and right curved corner portions 38, respectively, and a pair of left and right mounting pieces 41 which extend rearwardly from the upper ends of the left and right side pieces 39, respectively. The lower half portions of the left and right side pieces 39 form parallel portions 40 which are mutually parallel and extend linearly in the upward/downward direction.

The striker 36 is fixed to the bracket 30 by inserting the left and right mounting pieces 41 into the left and right striker mounting grooves 31 through the left and right insertion holes 32 of the bracket 30, respectively, and welding the left and right mounting pieces 41 onto the inner surfaces of the left and right striker mounting grooves 31.

The movement restriction member 45, which is a member that was obtained by pressing sheet metal, is provided with a body 46 which is parallel to a plane in which (the engaging portion 37, the curved corner portions 38 and the parallel portions 40 of) the striker 36 is positioned, and a contacting portion 51 which extends forwardly from the upper end of the body 46. A projection 52 is formed on the upper surface of the contacting portion 51.

The dimensions in the leftward/rightward direction of the body 46 except the upper part thereof are slightly wider than the distance between the opposing surfaces of the left and right side pieces 39, and the dimensions in the leftward/rightward direction of the upper part of the body 46 are slightly narrower than the distance between the opposing surfaces of the left and right side pieces 39. Furthermore, upward/downward dimensions of the movement restriction member 45 excluding the projection 52 are substantially the same as the distance between the upper surface of the engaging portion 37 and the lower surface of the bracket 30. Furthermore, the lower end portion of a central portion of the body 46, with respect to the leftward/rightward direction, is provided with a hook receiving recess 47 having a vertically-elongated rectangular front elevational shape, and a peripheral border flange 48 is provided on the peripheral border of the hook receiving recess 47 and projects in a forward direction. The lower portion of the movement restriction member 45 is provided with a pair of left and right side spacers 49 which are formed at the left and right sides of the hook receiving recess 47, respectively. The upper portion of the movement restriction member 45 forms an interconnecting portion 50, which connects the left and right side spacers 49.

The movement restriction member 45 is fixed to the bracket 30 and to the striker 36 by bringing the contacting portion 51 into contact with the undersurface of the bracket 30 while fitting the projection 52 into the recess 33 of the bracket 30 and bringing the left and right side edges of the body 46 into contact with the rear surfaces of the left and right side pieces 39, respectively, welding the contacting portion 51 to the undersurface of the bracket 30, and welding the left and right side edges of the body 46 (the side spacers 49 and the interconnecting portion 50) to the rear surfaces of the left and right side pieces 39.

Out of the above-described structure, the seat cushion 26A, the seat back 26B, the upper rails 27, the lower rails 28, the links 29 and the brackets 30 constitute components of the rear row seat 25.

Descriptions in regard to when the rear row seat 25 is rotatably moved using the links 29, and in regard to the operation of the lock mechanism 15 and the locking member 35 upon another automobile colliding with a side of the present automobile when the rear row seat 25 is in the usage position, will given hereinafter.

When the seat cushion 26A, the seat back 26B, the upper rails 27 and the lower rails 28 are positioned at the storage position, the locking member 35 does not interconnect (contact) with any other member. When the seat cushion 26A, the seat back 26B, the upper rails 27 and the lower rails 28 are rotatably moved to the usage position, the left and right locking members 35 enter inside the lower space underneath the high-level floor 13 through the left and right though-holes 14 that are formed in the high-level floor 13. At this instance, (since the lock-release device has not been operated) the hook 16 and the pawl 17 are positioned at the unlocked position and the engaged position, respectively, and the engaging portion 37 of the striker 36 which has entered inside the lower space underneath the high-level floor 13 engages with the engaging groove of the hook 16. Subsequently, since the hook 16 that was positioned at the unlocked position is rotated to the locked position by the entry force (pressing force) of the striker 36, and the pawl 17 holds the hook 16 at the locked position, the seat cushion 26A, the seat back 26B, the upper rails 27 and the lower rails 28 are held at the usage position. As shown in FIG. 3, since the leftward/rightward distance between the inner surfaces of the hook receiving recess 47 (peripheral border flange 48) is greater than the thickness of the hook 16 (dimensions in the leftward/rightward direction), the hook 16 can smoothly engage with the striker 36 without contacting the movement restriction member 45 (the hook receiving recess 47 and the peripheral border flange 48).

If another automobile collides with a side of the present automobile in this state, the rear row seat 25 moves relative to the vehicle floor 10 in the leftward/rightward direction due to the force of the collision force. However, upon the locking member 35 relatively moving in the leftward/rightward direction with respect to the lock mechanism 15 (hook 16) together with the leftward/rightward movement of the rear row seat 25, a brake is applied to the leftward/rightward movement of the rear row seat 25 by the inner surfaces (the inner surfaces of the left and right left and right side spacers 49) of the hook receiving recess 47 (peripheral border flange 48) of the movement restriction member 45 colliding against (abutting) the side surfaces of the hook 16. As shown in FIG. 3, before a collision occurs, since gaps S1 between the inner surfaces of the hook receiving recess 47 (peripheral border flange 48) and the side surfaces of the hook 16 are shorter than gaps S2 between the inner surfaces of the left and right parallel portions 40 and the side surfaces of the hook 16, the time it takes for an inner surface of the hook receiving recess 47 (peripheral border flange 48) to collide against (contact) a side surface of the hook 16 upon a collision occurring is shorter compared to the time it takes for an inner surface of the left and right parallel portions 40 to collide against (contact) a side surface of the hook 16 in the case where the movement restriction member 45 is not mounted to the striker 36. In other words, the moving speed of the rear row seat 25 in the lateral direction upon a side surface of the hook 16 colliding against an inner surface of the hook receiving recess (peripheral border flange 48) is slower compared to the moving speed of the rear row seat 25 in the lateral direction upon a side surface of the hook 16 colliding against (contacting) an inner surface of the left and right parallel portions 40 in the case where the movement restriction member 45 is not mounted to the striker 36. Accordingly, since the force of collision on the hook 16 from the locking member 35 is reduced, the moving amount of the rear row seat 25 in the lateral direction can be reduced by the locking member 35 and the lock mechanism 15 (hook 16).

Upon an occupant operating the lock-release device that is provided on the inclined connecting surface 18, the pawl 17 moves to the above-mentioned disengagement position against the biasing force of the tension spring, and the hook 16 is released. Accordingly, if the seat cushion 26A, the seat back 26B, the upper rails 27 and the lower rails 28 are pushed forwards upon the occupant folding the seat back 26B, since the engaging portion 37 of the striker 36 is removed upwardly from the engaging groove of the hook 16, and the locking member 35 is removed upwardly from the high-level floor 13 through the though-holes 14, if the seat cushion 26A, the seat back 26B, the upper rails 27 and the lower rails 28 are pushed further forward, the seat cushion 26A, the seat back 26B, the upper rails 27 and the lower rails 28 move to the storage position.

Note that if the occupant thereafter releases his/her hand from the lock-release device, the hook 16 and the pawl 17 return to the unlocked position and the engaged position, respectively, by the biasing force of the tension spring.

As described above, according to the present embodiment, in the case where another automobile collides with a side surface of the present automobile in a state where the seat cushion 26A, the seat back 26B, the upper rails 27 and the lower rails 28 are held at the usage position, the lateral movement amount of the rear row seat 25 can be reduced by utilizing the left and right side spacers 49 of the movement restriction member 45.

Moreover, since the upper parts of the left and right side spacers 49 are connected to the interconnecting portion 50, and the left and right side portions of the body 46 are welded (fixed) to the left and right side pieces 39, even if the hook 16 were to severely collide with the left and right side spacers 49 (the hook receiving recess 47 and the peripheral border flange 48) due to the impact of the collision, there is little risk of the movement restriction member 45 being severely damaged or the movement restriction member 45 falling out of the striker 36. Furthermore, by providing the movement restriction member 45, since a reinforcement effect can be achieved in which the rigidity of the striker 36 (locking member 35) is improved, the risk of the striker 36 (locking member 35) deforming due to the hook 16 colliding therewith can be reduced. Accordingly, even in the case where automobiles collide with each other with a large force, the above effects can be easily exhibited.

Furthermore, since the contacting portion 51 is welded to the lower surface of the bracket 30, and the projection 52 is engaged with the recess 33, the locking member 35 the above effects can also be easily exhibited.

A second embodiment of the present invention will be hereinafter discussed with reference to FIGS. 5 through 7. Note that members that are the same as those in the first embodiment are designated with the same designator, and detailed descriptions thereof have been omitted.

In this embodiment, at least one of the left and right brackets 30 and the locking members 35 of the rear row seat 25 is replaced by a bracket 55 and a locking member 60, shown in FIGS. 5 through 7.

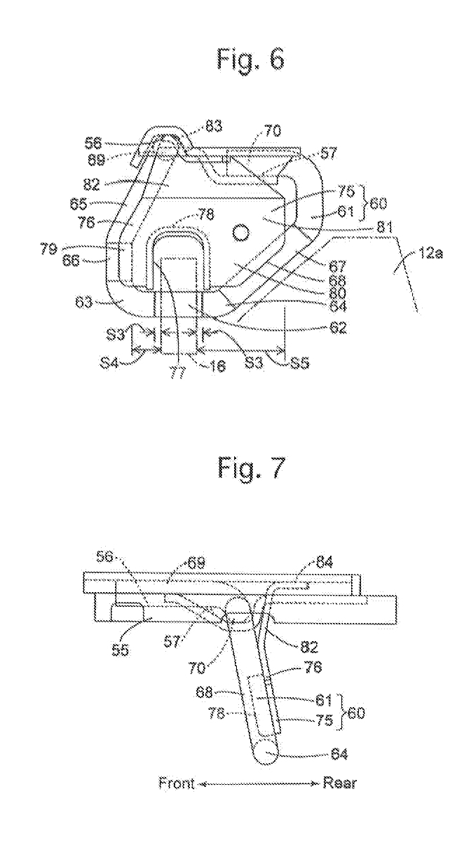

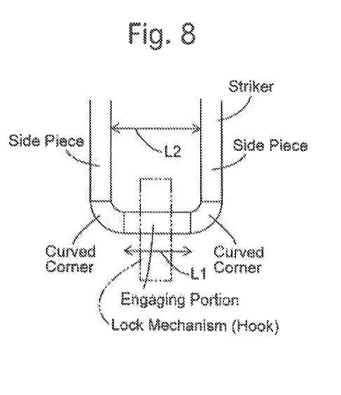

The metal bracket 55 is fixedly welded to the lower surface of the (at least one of the left and right) lower rails 28, at the vicinity of the rear end(s) thereof. As shown in FIGS. 5 and 6, a forward/rearward groove 56 which extends in the forward/rearward direction is formed in one side portion of the bracket 55 on the underside thereof, and a leftward/rightward groove 57 which extends in the leftward/rightward direction is formed in the other side portion of the bracket 55 on the upper side thereof.

The locking member 60 is provided with a striker 61 and a movement restriction member 75, which are both made out of metal.

The striker 61 is a bilaterally asymmetrical member that is formed by bending a straight metal rod, which has a circular sectional shape. The striker 61 is provided with an engaging portion 62 which extends linearly in the leftward/rightward direction and constitutes a lower end of the striker 61, left and right curved corner portions 63 and 64 which curve in an arcuate shape upwards from the left and right ends of the engaging portion 62, respectively, left and right side pieces 65 and 67 which extend upwardly from the upper ends of the curved corner portion 63 and the curved corner portion 64, respectively, a forwardly-extending mounting piece 69 which extends forwardly from the upper end of the side piece 65, and a sideward-extending mounting piece 70 which extends toward the side piece 65 from the upper end of the side piece 67. The lower half portion of the side piece 65 forms an upward/downward extension portion 66 which extends linearly in the upward/downward direction, and the lower half portion of the side piece 67 forms an inclined escape portion 68 that is inclined with respect to the upward/downward direction.

The striker 61 is fixed to the bracket 55 by inserting the sideward-extending mounting piece 70 into the left and right grooves 57, fitting the forwardly-extending mounting piece 69 into the forward/rearward groove 56, welding the sideward-extending mounting piece 70 onto the inner surfaces of the left and right grooves 57, and welding the forwardly-extending mounting piece 69 onto the inner surface of the forward/rearward groove 56.

The movement restriction member 75, which is a member that was obtained by pressing sheet metal, is provided with a body 76 which is parallel to a plane in which the striker 61 is positioned, an upper inclined portion 82 which extends upwardly in a rearwardly inclined direction from an upper edge of the body 76, a projection 83 which projects upwardly from one side edge portion of an upper edge of the upper inclined portion 82, and a contacting portion 84 which extends rearwardly from the upper edge portion of the upper inclined portion 82 except for the above-mentioned side edge portion.

The dimensions in the leftward/rightward direction of the body 76 are slightly wider than the distance between the opposing surfaces of the lower-half portions of the side pieces 65 and 67. Furthermore, upward/downward dimensions of the movement restriction member 75 excluding the projection 83 are substantially the same as the distance between the upper surface of the engaging portion 62 and the lower surface of the bracket 55. Furthermore, the lower end portion of a central portion, with respect to the leftward/rightward direction, of the body 76 is provided with a hook receiving recess 77 having a vertically-elongated rectangular front elevational shape, and a peripheral border flange 78 is provided on the peripheral border of the hook receiving recess 77 and projects in a forward direction. The lower portion of the body 76 is provided with a pair of left and right side spacers 79 and 80 which are formed at the left and right sides of the hook receiving recess 77, respectively. The upper portion of the body 76 forms an interconnecting portion 81, which connects the left and right side spacers 79 and 80.

The movement restriction member 75 is fixed to the bracket 55 and to the striker 61 by bringing the contacting portion 84 into contact with the undersurface of the bracket 55 while fitting the projection 83 into the forward/rearward groove 56 of the bracket 55 and bringing the left and right side edges of the body 76 into contact with the rear surfaces of the left and right side pieces 65 and 67, respectively, welding the contacting portion 84 to the undersurface of the bracket 55, and welding the outer edge portions of the side spacers 79 and 80 to the rear surfaces of the side pieces 65 and 67, and welding one side edge portion of the interconnecting portion 81 to the rear surface of the side piece 65.

In the present embodiment, out of the above-described structure, the seat cushion 26A, the seat back 26B, the upper rails 27, the lower rails 28, the links 29 and the brackets 55 constitute components of the rear row seat 25.

The locking member 60 of the present embodiment having the above-described configuration also exhibits the same operational effect as that of the locking member 35 of the first embodiment.

Namely, if another automobile collides with a side of the present automobile in the state where the rear row seat 25 is positioned at the usage position, upon the locking member 60 relatively moving in the leftward/rightward direction with respect to the lock mechanism 15 (hook 16), a brake is applied to the leftward/rightward movement of the rear row seat 25 by the inner surfaces (the inner surfaces of the left and right side spacers 79 and 80) of the hook receiving recess 77 (peripheral border flange 78) of the movement restriction member 75 colliding against (abutting) the side surfaces of the hook 16. As shown in FIG. 6, before a collision occurs, since gaps S3 between the inner surfaces of the hook receiving recess 77 (peripheral border flange 78) and the side surfaces of the hook 16 are shorter than gaps S4 and S5 between the inner surfaces of the upward/downward extension portion 66/the inclined escape portion 68 and the side surfaces of the hook 16, the time it takes for an inner surface of the hook receiving recess 77 (peripheral border flange 78) to collide against (contact) a side surface of the hook 16 upon a collision occurring is short compared to the time it takes for an inner surface of the left and righty upward/downward extension portion 66/the inclined escape portion 68 to collide against (contact) a side surface of the hook 16 in the case where the movement restriction member 75 is not mounted to the striker 61. Accordingly, the lateral movement amount of the rear row seat 25 can be reduced in the same manner as with the locking member 35 of the first embodiment.

Furthermore, in the present embodiment, when the rear row seat 25 is rotatably moved from the storage position to the usage position, as shown in FIG. 6, since the inclined escape portion 68 can avoid a protruding part 12a formed on the surface of the low-level floor 12, the rear row seat 25 can be smoothly rotatably-moved even in the case where the low-level floor 12 is provided with the protruding part 12a.

Although the present invention has been described above using the above embodiments, the present invention can be implemented while making various modifications thereto.

For example, at least one of the peripheral border flange 48, the interconnecting portion 50, the contacting portion 51 and the projection 52 (and the recess 33 from the bracket 30) can be omitted from the movement restriction member 45, and one of the side spacers 49 can be omitted. Furthermore, at least one of the peripheral border flange 78, the interconnecting portion 81, the upper inclined portion 82, the projection 83, and the contacting portion 84 can be omitted from the movement restriction member 75, and one of the side spacers 79 and 80 can be omitted. If such omissions are carried out, when a movement acceleration occurs in the lateral direction in the automobile (vehicle), although the risk of severe damage occurring in the movement restriction member 45/75 and the risk of the movement restriction member 45/75 falling out of the striker 36/61 increase somewhat, a remarkable operational effect can still be achieved compared to the prior art, in which the movement restriction member 45/75 is not fixed to the striker 36/61. Note that in the case where the contacting portion 51/84 is omitted, it is desirable for the upper surface of the body 46 or the upper surface of the upper inclined portion 82 to abut against the lower surface of the bracket 30/55. Furthermore, in the case where the interconnecting portion 50 and the contacting portion 51 are omitted from the movement restriction member 45, the side spacers 49 can extend upward and the upper ends of the side spacers 49 can be brought into contact with the underside of the bracket 30; and in the case where the interconnecting portion 81, the upper inclined portion 82, the projection 83 and the contacting portion 84 are omitted from the movement restriction member 75, the side spacers 79/80 can extend upward and the upper ends of the side spacers 79/80 can be brought into contact with the underside of the bracket 55.

Furthermore, in the first and second embodiments, the entirety of the side spacers 49 of the movement restriction member 45 and the entirety of the side spacers 79 and 80 of the movement restriction member 75 are respectively positioned within the width between the curved corner portions 38 and the curved corner portions 63 and 64, in the leftward/rightward direction positioned immediately therebelow, respectively, in a front elevational view. However, the shape of the movement restriction member 45 and of the movement restriction member 75 can be set such that the inner portions of the side spacers 49 encroaches the area directly above the engaging portion 37 somewhat, or such that the inner portions of the side spacers 79 and 80 encroaches the area directly above the engaging portion 62 somewhat.

In addition, the contacting portion 51 of the movement restriction member 45 can be extended rearward, and the contacting portion 84 of the movement restriction member 75 can be extended forward.

Furthermore, through-holes can be formed in the brackets 30 or 55, and the projections 52 or 83 can be fitted through the through-holes.

Furthermore, the seat can be modified to be a detachably mountable seat which can be detachably mounted onto the vehicle floor 10 by utilizing the lock mechanism 15 and the locking member.

Furthermore, the locking member 35/60 can be provided on the vehicle floor 10 and the lock mechanism 15 can be provided on the rear row seat 25.

Furthermore, a seat placement portion, in which one of the locking member and the lock mechanism is provided, can be formed on a seat (not shown in the drawings; a seat placement body) that is fixed to the vehicle floor 10, and the other of the locking member and the lock mechanism can be formed on a child seat, not shown in the drawings, in which the child seat is detachably mountable to a rear seat.

Furthermore, the upper rails 27 and the lower rails 28 can be omitted from the rear row seat 25, and the locking member 35/60 or the lock mechanism 15 can be provided on the underside of the seat cushion 26A.

### INDUSTRIAL APPLICABILITY

According to the present invention, the gaps in the leftward/rightward direction between the lock mechanism and the left and right side spacers, when the lock mechanism is engaged with the engaging portion of the striker, is shorter than the distance between the lock mechanism and the left and right side pieces. Accordingly, even if the seat is moved in the lateral direction due to lateral acceleration, since the left and right side spacers collide with the lock mechanism at a timing in which the striker slightly moves laterally relative to the lock mechanism (at an instant at which the movement speed is slow), it is possible to suppress the lateral movement amount of the seat using the locking member (the striker and the movement restriction member 45) and the locking mechanism.

Moreover, since a reinforcing effect is achieved in which the rigidity of the striker (locking member) is improved by providing the side spacers, the risk of the striker (the locking member) being deformed by the collision with the lock mechanism is reduced.

### REFERENCE SIGNS LIST

10 Vehicle floor (seat placement portion)
11 Stepped floor
12 Low-level floor (storage recess)
12a Protruding part
13 High-level floor (seat placement portion)
14 Though-holes
15 Lock mechanism
16 Hook
17 Pawl
18 Inclined connecting surface
20 Front row seat
25 Rear row seat (seat)
26A Seat cushion
26B Seat back
27 Upper rails
28 Lower rails
29 Link
30 Bracket
31 Striker mounting groove
32 Insertion hole
33 Recess
35 Locking member
36 Striker
37 Engaging portion
38 Curved corner portion
39 Side piece
40 Parallel portions
41 Mounting piece
45 Movement restriction member
46 Body
47 Hook receiving recess
48 Peripheral border flange
49 Side spacer
50 Interconnecting portion
51 Contacting portion
52 Projection
55 Bracket
56 Forward/rearward groove
57 Leftward/rightward groove
60 Locking member
61 Striker
62 Engaging portion
63 64 Curved corner portions
65 67 Side pieces
66 Upward/downward extension portion
68 Inclined escape portion
69 Forwardly-extending mounting piece
70 Sideward-extending mounting piece
75 Movement restriction member
76 Body
77 Hook receiving recess
78 Peripheral border flange
79 80 Side spacers
81 Interconnecting portion
82 Upper inclined portion
83 Projection
84 Contacting portion

1. A locking member of a vehicle seat device, which includes a vehicle seat device provided with a seat which is installable onto and removable from a seat placement portion formed on a seat placement body, and a lock mechanism provided on one of said seat placement portion and said seat, wherein said locking member is provided on the other of said seat placement portion and said seat and said locking member is locked by said lock mechanism when said seat is installed onto said seat placement portion,
wherein said locking member comprises:
a striker provided with a pair of left and right side pieces which extend from said other of said seat placement portion and said seat; a pair of curved corner portions which curve in directions mutually toward each other from ends of said pair of side pieces; and an engaging portion, linearly extending in the leftward/rightward direction, which is connected to said pair of curved corner portions and is disengageably engaged with said lock mechanism; and
a movement restriction member including at least one side spacer which forms a gap in the leftward/rightward direction between said engaging portion and said lock mechanism, to which said engaging portion is engaged, said side spacer being fixed to at least one said side piece so that positions in the leftward/rightward direction of at least one part of said movement restriction member are the same as those of the left and right said curved corner portions.

2. The locking member of a vehicle seat device according to claim 1, comprising a pair of left and right said side spacers.

3. The locking member of a vehicle seat device according to claim 2, wherein said movement restriction member is provided with an interconnecting portion which connects the ends of said other of said seat placement portion and said seat of said pair of side spacers, and is fixed to said pair of side spacers.

4. The locking member of a vehicle seat device according to claim 1, wherein said movement restriction member contacts said other of said seat placement portion and said seat.

5. The locking member of a vehicle seat device according to claim 1, wherein said movement restriction member is provided with a contacting portion which extends forwardly or rearwardly from said striker, and which contacts said other of said seat placement portion and said seat.

6. The locking member of a vehicle seat device according to claim 5, wherein said contacting portion is provided with a projection which fits in a hole or a recess that is formed in said other of said seat placement portion and said seat.

7. A vehicle seat device, wherein the locking member according to claim 1 is mounted onto said seat which is installable onto and removable from said seat placement portion, which is provided with said lock mechanism.

8. A seat placement body, comprising the locking member according to claim 1, and wherein said seat, which is provided with said lock mechanism, is installable and removable with respect to said seat placement body.
